(19) United States
(12) Patent Application Publication
(10) Pub. No.: US 2012/0029837 A1
(43) Pub. Date: Feb. 2, 2012

(54) Engine revolution meter

(75) Inventors: Takahira Katoh, Kariya-city (JP); Kenichi Hiura, Kariya-city (JP); Minoru Sumiya, Nagoya-city (JP)

(73) Assignee: DENSO CORPORATION, Kariya-city (JP)

(21) Appl. No.: 13/135,772

(22) Filed: Jul. 14, 2011

(30) Foreign Application Priority Data
Jul. 30, 2010 (JP) 2010-171546

(51) Int. Cl. G06F 19/00

(52) U.S. Cl. 702/33

(57) ABSTRACT

An engine revolution meter for displaying an engine revolution number display value includes an obtaining device, a calculating device, and a determining device. The obtaining device obtains an engine revolution number measurement value corresponding to a measured revolution number of an engine of a vehicle. The calculating device calculates the display value based on the measurement value. The determining device determines whether the measurement value is greater or less than a reference value. When the determining device determines that the measurement value is less than the reference value, the calculating device calculates the display value in such a manner that the display value changes at a first rate different from a second rate at which the measurement value changes.

### CROSS REFERENCE TO RELATED APPLICATION

This application is based on and claims priority to Japanese Patent Application No. 2010-171546 filed on Jul. 30, 2010, the contents of which are incorporated herein by reference.

### FIELD OF THE INVENTION

The present invention relates to an engine revolution meter for a vehicle.

### BACKGROUND OF THE INVENTION

Vehicles have been progressively electronized, and a sensor and a meter display actuator (e.g., a motor and a graphic circuit) have been sophisticated so that a meter display response speed (i.e., responsivity) can be improved. There is a concern that a pointer needle of an engine revolution meter wiggles due to an improved meter display response speed so that a meter display can flicker. JP-6-242134 discloses a technique for reducing a small motion of the pointing needle during an engine idle condition.

In recent years, there has been an increase in the number of vehicles equipped with a stop-idle feature that turns an engine OFF when a vehicle is stopped, for example, at a traffic light. In such a vehicle, the engine frequently switches between an idling condition and an OFF condition. Accordingly, the pointing needle of the engine revolution meter frequently moves between an engine idling RPM value and zero. The movement of the pointing needle between the engine idling RPM value and zero is relatively large. A driver may feel uncomfortable with such a large and frequent movement of the pointing needle of the engine revolution meter.

JP-6-242134 fails to disclose how to control the movement of the pointing needle when the engine switches between the idling condition and the OFF condition.

### SUMMARY OF THE INVENTION

In view of the above, it is an object of the present invention to provide an engine revolution meter for displaying a change in an engine revolution number comfortably to a driver.

According to an aspect of the present invention, an engine revolution meter for displaying an engine revolution number display value includes an obtaining device, a calculating device, and a determining device. The obtaining device obtains an engine revolution number measurement value corresponding to a measured revolution number of an engine of a vehicle. The calculating device calculates the display value based on the measurement value. The determining device determines whether the measurement value is greater or less than a reference value. When the determining device determines that the measurement value is less than the reference value, the calculating device calculates the display value in such a manner that the display value changes at a first rate different from a second rate at which the measurement value changes.

### BRIEF DESCRIPTION OF THE DRAWINGS

The above and other objects, features, and advantages will become more apparent from the following description and drawings in which like reference numerals depict like elements. In the drawings:

FIG. 1 is a block diagram of an engine revolution meter according to an embodiment of the present invention;

FIG. 2 is a flow chart of a control process performed in the engine revolution meter;

FIG. 3 is a flow chart of a calculation process performed in the engine revolution meter;

FIG. 4 is a diagram illustrating an example of a relationship between a measurement value and a display value observed when the measurement value changes;

FIG. 5 is a diagram illustrating another example of the relationship between the measurement value and the display value observed when the measurement value changes;

FIG. 6 is a diagram illustrating an example of the relationship between the measurement value and the display value observed when an engine is stopped;

FIG. 7 is a diagram illustrating another example of the relationship between the measurement value and the display value observed when the engine is stopped;

FIG. 8 is a diagram illustrating an example of the relationship between the measurement value and the display value observed when the engine is started;

FIG. 9 is a diagram illustrating another example of the relationship between the measurement value and the display value observed when the engine is started;

FIG. 10 is a diagram illustrating the relationship between the measurement value and the display value according to a modification; and

FIG. 11 is a diagram illustrating a relationship among the measurement value, the display value, and the brightness for displaying the display value.

### DETAILED DESCRIPTION OF THE PREFERRED EMBODIMENT

### Embodiment

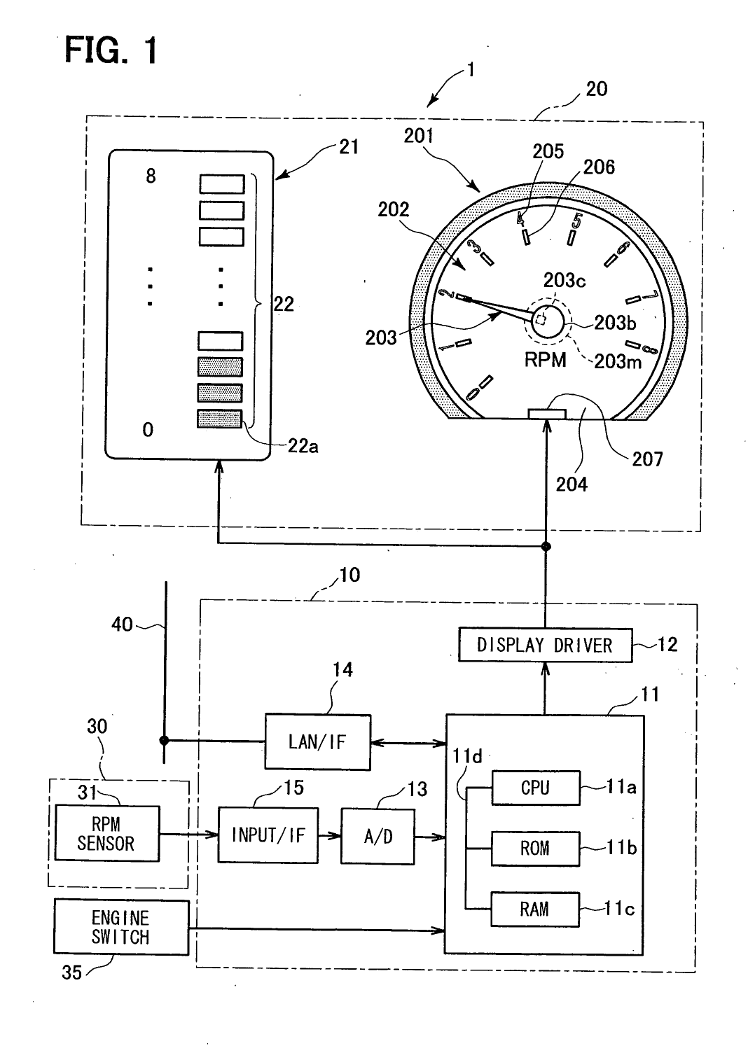

An engine revolution meter 1 according to an embodiment of the present invention is described below with reference to FIG. 1. The engine revolution meter 1 includes a control unit 10, a display 20, and a sensor unit 30.

The control unit 10 has a controller 11, a display driver 12 connected to the controller 11, a local area network (LAN) interface (IF) 14 connected to an in-vehicle LAN 40, and an input interface (IF) 15 connected to a sensor unit 30. The controller 11 can perform data communication through the LAN/IF 14 with on-board devices connected to the in-vehicle LAN 40.

The controller 11 includes a central processing unit (CPU) 11a, a read only memory (ROM) 11b, and a random access memory (RAM) 11c. The ROM 11a stores control program performed by the CPU 11a. The CPU 11a, the ROM 11b, and the RAM 11c are connected together through a bus line 11d. Thus, data is transmitted among the CPU 11a, the ROM 11b, and the RAM 11c so that the controller 11 can serve as a microcomputer.

The display driver 12 drives and controls the display 20.

The input/IF 15 receives an engine RPM signal from an engine revolution sensor 31 incorporated in the sensor unit 30 and outputs the an engine RPM signal to the controller 11. For example, the input/IF 15 can include a voltage converter or a waveform shaper for converting the an engine RPM signal into a signal form that can be processed by the controller 11.

The display 20 is located on an instrument panel solely or together with another meter or display apparatus. The display 20 includes at least one of a mechanical meter 201 and a digital meter 21.

The mechanical meter 201 includes a dial 202 and a needle 203.

The dial 202 is made of a translucent thin plate. Numbers (or characters) 205 and corresponding markings 206 are printed on the outer edge of the front side of the dial 202 and arranged at approximately regular intervals in a circumferential direction of the dial 202. The numbers 205 and markings 206 indicate an engine revolution number, for example, in units of revolutions per minute (RPM). A non-translucent, colored layer 204 is formed on the dial 202 in such a manner that the numbers 205 and markings 206 are not covered with the colored layer 204.

The number 205 and the corresponding marking 206 are illuminated from the back side of the dial 202 by a common light source (not shown), such as a light-emitting diode (LED), located at a position corresponding to the number 205 and the marking 206. Each light source is controlled and illuminated by a light source driver (not shown) incorporated in the display driver 12. For example, the light source driver PWM-controls the brightness of the light source according to a command from the controller 11. Alternatively, the number 205 and the corresponding marking 206 can be illuminated by separate light sources.

A root of the needle 203 is attached to a rotating shaft (not shown) of a motor 203m. For example, the motor 203m can be a step motor. The display driver 12 calculates the rotation amount and direction of the motor 203m based on the present position of the motor 203m and an engine RPM display value received from the controller 11. Then, the display driver 12 drives the motor 203m so that the motor 203m can rotate by the calculated rotation amount in the calculated rotation direction. For example, the present position of the motor 203m can be measured from an origin point corresponding to the marking 206 with the number 205 of “0”.

The front side of the needle 203 is translucent. A light source 203c, such as a LED, is located near the root of the needle 203 and emits light in a direction toward the tip of the needle 203 so that the needle 203 can be illuminated. A cover 203b is attached to the root of the needle 203 to cover the light source 203c. Thus, the light source 203c is hidden from user's view.

As described above, the number 205, the marking 206, and the needle 203 on the dial 202 of the mechanical meter 201 are illuminated by separate light sources. Alternatively, a lamp 207 can be placed in a lower position on the front side of the dial 202 to illuminate the entire mechanical meter 201.

The digital meter 21 has a display area 22 for displaying a bar graph constructed with multiple segments 22a arranged in one direction. Each segment 22a has an approximately rectangular light-emitting surface. A number and/or marking can be displayed along with the corresponding segment 22a in the display area 22.

Each segment 22a is formed with a light source such as a LED or a vacuum fluorescent display (VFD) and controlled by a segment driver incorporated in the display driver 12. Specifically, the display driver 12 illuminates the segments 22a based on the engine RPM display value received from the controller 11 so that the bar graph indicative of the engine RPM display value can be displayed on the display area 22.

In an example shown in FIG. 1, the rectangular-shaped segments 22a are arranged in one direction so that the engine RPM display value can be displayed as a bar graph. The shape and arrangement of the segment 22a are not limited to the example shown in FIG. 1, as long as the number of the segments 22a to be illuminated varies depending on the engine RPM display value. For example, the segments 22a can be shaped and arranged so that the engine RPM display value can be displayed as a line graph, a circular graph, or the like. Likewise, the display area 22 is not limited to a rectangular shape. For example, the display area 22 can be polygonal, circular, ellipsoidal, or the like.

The display 20 can be configured as a graphic meter using an organic electroluminescence (EL), a dot-matrix liquid crystal display (LCD), a plasma display, or the like.

As mentioned previously, the sensor unit 30 includes the engine revolution sensor 31. The engine revolution sensor 31 measures the engine RPM and outputs the engine RPM signal indicative of the engine RPM measurement value. The engine RPM signal is inputted through the input/IF 15 to the controller 11 so that the controller 11 can obtain the engine RPM measurement value. Thus, the input/IF 15 can serve as an engine revolution number obtaining device. It is noted that when the engine RPM signal is an analog signal, an analog-to-digital (A/D) converter 13 can be interposed between the input/IF 15 and the controller 11, as shown in FIG. 1.

Alternatively, engine RPM information associated with the engine RPM measurement value can be inputted from the on-board device connected to the in-vehicle LAN 40 to the controller 11 through the LAN/IF 14 so that the controller 11 can obtain the engine RPM measurement value. In such an approach, wiring between the control unit 10 and the sensor unit 30 can become unnecessary. In this case, the LAN/IF 14 can serve as an engine revolution number obtaining device.

An engine switch 35 shown in FIG. 1 can be a traditional ignition switch or a push switch used to start and stop an engine of a vehicle with an electronic smart key system. When the engine switch 35 is turned ON to start the engine, the engine switch 35 outputs an engine start command signal to the control unit 10. In contrast, when the engine switch 35 is turned OFF to stop the engine, the engine switch 35 outputs an engine stop command signal to the control unit 10. In an example shown in FIG. 1, the engine switch 35 is connected directly to the control unit 10. Alternatively, the engine switch 35 can be connected through the in-vehicle LAN 40 to the control unit 10.

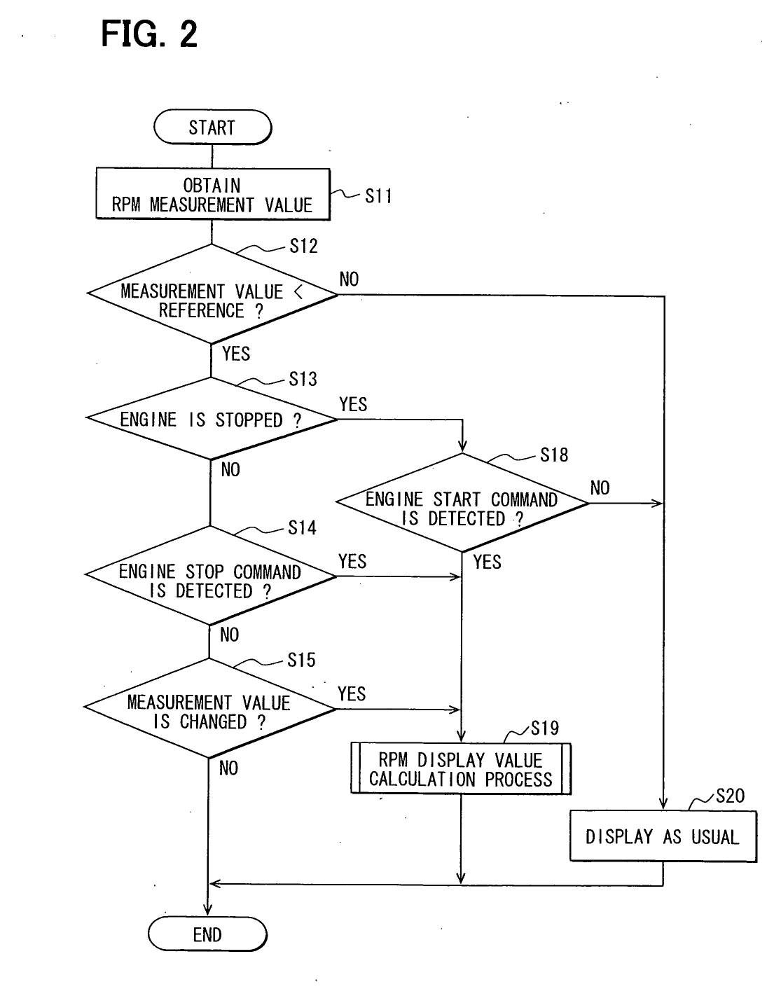

FIG. 2 is a flow chart illustrating a control process that is performed by the CPU 11a of the controller 11 in accordance with the control program.

The control process starts at S11, where the controller 11 obtains the engine RPM measurement value. Specifically, at S11, the engine RPM signal outputted from the engine revolution sensor 31 is converted by the A/D converter 13 into engine RPM data, and the controller 11 obtains the engine RPM measurement value based on the engine RPM data. Alternatively, at S11, the controller 11 can receive engine RPM information through the LAN/IF 14 from the on-board device connected to the in-vehicle LAN 40 and obtain the engine RPM measurement value based on the engine RPM information.

Then, the control process proceeds to S12, where the controller 11 compares the engine RPM measurement value, obtained at S11, with a predetermined reference value prestored in the ROM 11b. For example, the reference value can be an engine idle RPM, an engine RPM during charging of a battery of a hybrid vehicle, or an upper limit (e.g., 2000 rpm) of an engine RPM range a user usually uses.

If the engine RPM measurement value is greater than the reference value corresponding to No at S12, the control process proceeds to S20. At S20, the controller 11 displays the display 20 as usual. Specifically, at S20, the controller 11 calculates the engine RPM display value without any processing on the engine RPM measurement value and outputs the engine RPM display value (i.e., the engine RPM measurement value) to the display driver 12. Thus, the display 20 displays the exact engine RPM measurement value.

In contrast, if the engine RPM measurement value is equal to or less than the reference value corresponding to YES at S12, the control process proceeds to S13. At S13, the controller 11 determines, based on the engine RPM measurement value, whether the engine is in a stopped condition. For example, when the engine RPM measurement value less than a predetermined threshold value (e.g., 100 rpm) is kept for a predetermined period, the controller 11 can determine that the engine is in the stopped condition.

If the controller 11 determines that the engine is in the stopped condition corresponding to YES at step S13, the control process proceeds to S18. At S18, the controller 11 determines whether the engine start command signal is received from the engine switch 35. If the controller 11 does not receive the engine start command signal from the engine switch 35 corresponding to NO at S18, the control process proceeds to S20. In contrast, if the controller 11 receives the engine start command signal from the engine switch 35 corresponding to YES at S18, the control process proceeds to S19. At S19, the controller 11 performs a display value calculation process for calculating the engine RPM display value by correcting the engine RPM measurement value. The calculation process is discussed in detail later.

In contrast, if the controller 11 determines that the engine is not in the stopped condition corresponding to NO at step S13, the control process proceeds to S14. At S14, the controller 11 determines whether the engine stop command signal is received from the engine switch 35. If the controller 11 receives the engine stop command signal from the engine switch 35 corresponding to YES at S14, the control process proceeds to S19. In contrast, if the controller 11 does not receive the engine stop command signal from the engine switch 35 corresponding to NO at S14, the control process proceeds to S15.

At S15, the controller 11 determines whether there is a change in the engine RPM measurement value. For example, when a difference between the present engine RPM measurement value and the next previous RPM measurement value exceeds 5 rpm, the controller 11 can determine that there is the change in the engine RPM measurement value. If the controller 11 determines that there is the change in the engine RPM measurement value corresponding to YES at S15, the control process proceeds to S19. In contrast, if the controller 11 determines that there is no change in the engine RPM measurement value corresponding to NO at S15, the control process ends so that the present display condition can be continued.

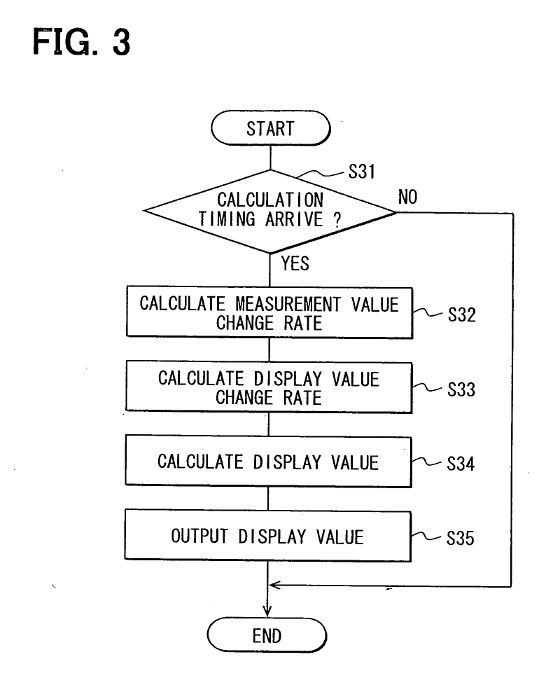

Next, the calculation process performed at S19 in the flow chart of FIG. 2 is described below with reference to a flow chart of FIG. 3. The calculation process starts at S31, where the controller 11 determines whether a timing of calculation of the engine RPM display value arrives. For example, the calculation timing can arrive when the controller 11 determines that there is the change in the engine RPM measurement value, or when a predetermined time is elapsed after the controller 11 determines that there is the change in the engine RPM measurement value. Alternatively, the calculation timing can arrive when the controller 11 receives the engine start or stop command signal, or when a predetermined time is elapsed after the controller 11 receives the engine start or stop command signal. Alternatively, the calculation timing can arrive when the controller 11 determines that the engine is in the stopped condition after receiving the engine stop command signal. Alternatively, the calculation timing can arrive when the controller 11 determines that the engine RPM measurement value exceeds a predetermined threshold after receiving the engine start command signal.

If the controller 11 determines that the calculation timing arrives corresponding to YES at S31, the calculation process proceeds to S32. At S32, the controller 11 calculates the rate of the change in the engine RPM measurement value. For example, the controller 11 can calculate the engine RPM measurement value change rate by dividing the difference between the present engine RPM measurement value and the next previous RPM measurement value by a time interval at which the calculation process is performed. Alternatively, the previous engine RPM measurement values can be stored as historical data in the RAM 11c, and the engine RPM measurement value change rate can be calculated based on the historical data.

Then, the calculation process proceeds to S33, where the controller 11 calculates the rate of the change in the engine RPM display value based on the engine RPM measurement value change rate, which is calculated at S32. Specifically, the controller 11 calculates the engine RPM display value change rate in such a manner that the engine RPM display value change rate becomes less than the engine RPM measurement value change rate. If the next previous engine RPM display value change rate remains less than the engine RPM measurement value change rate, the next previous engine RPM display value change rate can be used as the engine RPM display value change rate.

Then, the calculation process proceeds to S34, where the controller 11 calculates the engine RPM display value based on the engine RPM display value change rate, which is calculated at S33, and the next previous engine RPM display value, which is stored in the RAM 11c. Then, the calculation process proceeds to S35, where the controller 11 outputs the engine RPM display value, which is calculated at S34, to the display driver 12 so that the display driver 12 can drive the display 20 based on the engine RPM display value. Then, the calculation process ends.

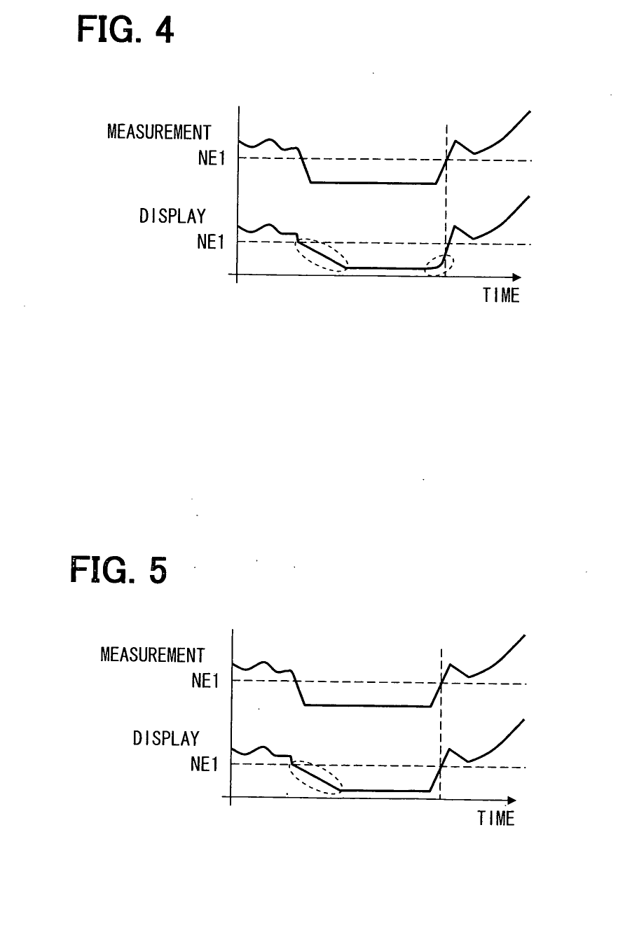

Below, relationships between the engine RPM measurement value and the engine RPM display value in the control process are described. Firstly, a relationship between the engine RPM measurement value and the engine RPM display value observed when the engine RPM measurement value below a reference value NE1 changes is described with reference to FIGS. 4 and 5.

As shown in FIG. 4, when the engine RPM measurement value decreases below the reference value NE1, the controller 11 determines that the calculation timing arrives. Thus, the engine RPM display value change rate is set less than the engine RPM measurement value change rate. Therefore, the engine RPM display value changes at a rate less than a rate at which the engine RPM measurement value changes. Then, when the engine RPM measurement value below the reference value NE1 starts to increase, the controller 11 determines that the calculation timing arrives. Thus, the engine RPM display value change rate is set less than the engine RPM measurement value change rate. Therefore, until the engine RPM measurement value increases above the reference value NE1, the engine RPM display value changes at the rate less than the rate at which the engine RPM measurement value changes.

It is noted that a user may want to know as soon as possible when the engine starts. To satisfy such a user demand, as shown in FIG. 5, only when the engine RPM measurement value below the reference value NE1 decreases, the engine RPM display value change rate can be set less than the engine RPM measurement value change rate. In other words, when the engine RPM measurement value below the reference value NE1 increases, the engine RPM display value change rate can be set equal to the engine RPM measurement value change rate. Alternatively, according to user demands, only when the engine RPM measurement value below the reference value NE1 increases, the engine RPM display value change rate can be set less than the engine RPM measurement value change rate.

In the examples shown in FIGS. 4 and 5, the calculation process is started (i.e., the calculating timing arrives) at the same time the engine RPM measurement value decreases below the reference value NE1 or the engine RPM measurement value below the reference value NE1 starts to increase. Alternatively, the calculation process can be started (i.e., the calculating timing can arrive), when a predetermined delay time is elapsed after the engine RPM measurement value decreases below the reference value NE1 or the engine RPM measurement value below the reference value NE1 starts to increase.

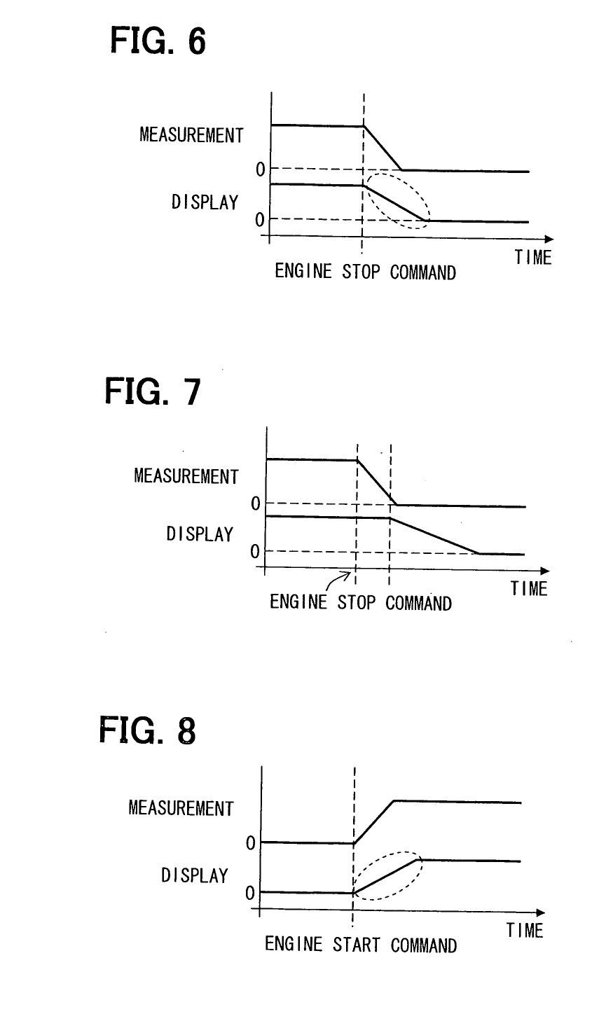

Secondary, a relationship between the engine RPM measurement value and the engine RPM display value observed when the engine is stopped is described with reference to FIGS. 6 and 7. As shown in FIG. 6, when the running engine is commanded to be stopped (i.e., when the controller 11 receives the engine stop command signal), the controller 11 determines that the calculation timing arrives. Thus, the engine RPM display value change rate is set less than the engine RPM measurement value change rate. In some types of engines, the engine RPM measurement value change rate during a time period from when the engine is commanded to be stopped to when the engine is completely stopped may depend on the engine RPM measurement value obtained at the time the engine is commanded to be stopped. In such an engine, a first mapping table between the engine RPM measurement value at the time the engine is commanded to be stopped and the engine RPM measurement value change rate during the time period from when the engine is commanded to be stopped to when the engine is completely stopped can be prestored in the ROM 11b. In such an approach, when the engine is commanded to be stopped, the engine RPM display value change rate can be set less than the engine RPM measurement value change rate by referring to the first mapping table.

In the example shown in FIG. 6, the calculation process is started (i.e., the calculating timing arrives) at the same time the controller 11 receives the engine stop command signal. Alternatively, the calculation process can be started (i.e., the calculating timing can arrive), when a predetermined delay time is elapsed after the controller 11 receives the engine stop command signal.

Alternatively, as shown in FIG. 7, the controller 11 can determine that the calculation timing arrives, when the engine RPM measurement value becomes zero after the running engine is commanded to be stopped (i.e., after the controller 11 receives the engine stop command signal). In this case, the engine RPM measurement value change ratio can be calculated by dividing the engine RPM measurement value at the time the engine is commanded to be stopped by the time period from when the engine is commanded to be stopped to when the engine RPM measurement value becomes zero. Thus, the engine RPM display value change rate can be set less than the calculated engine RPM measurement value change rate. Alternatively, the controller 11 can determine that the calculation timing arrives, when the engine RPM measurement value decreases below a predetermined value after the running engine is commanded to be stopped.

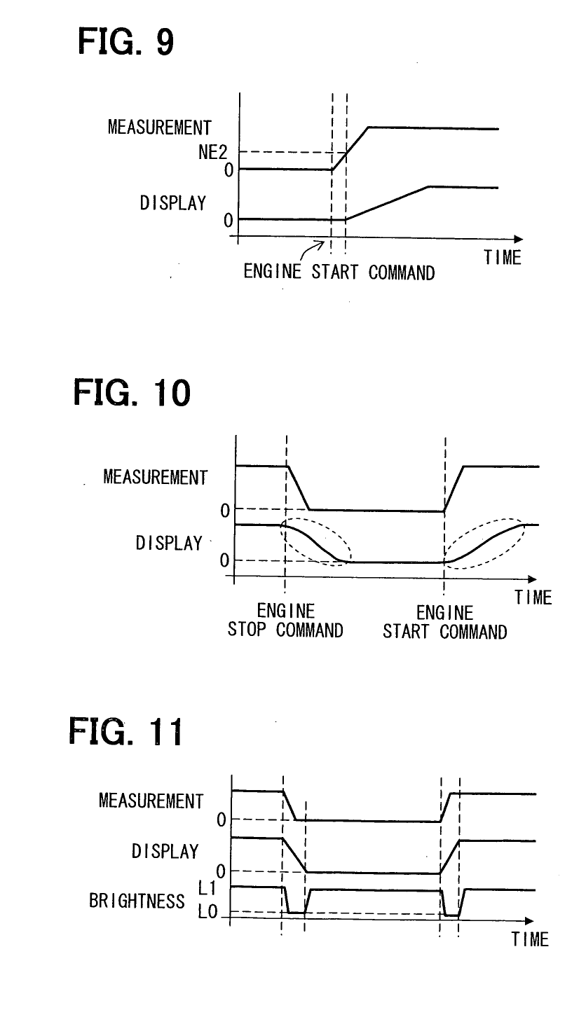

Thirdly, a relationship between the engine RPM measurement value and the engine RPM display value when the engine is started is described with reference to FIGS. 8 and 9. As shown in FIG. 8, when the stopped engine is commanded to be started (i.e., when the controller 11 receives the engine start command signal), the controller 11 determines that the calculation timing arrives. Thus, the engine RPM display value change rate is set less than the engine RPM measurement value change rate. In some types of engines, the engine RPM measurement value change rate during a time period from when the engine is commanded to be started to when the engine is completely started may depend on the engine RPM measurement value obtained at the time the engine is commanded to be started. In such an engine, a second mapping table between the engine RPM measurement value at the time the engine is commanded to be started and the engine RPM measurement value change rate during the time period from when the engine is commanded to be started to when the engine is completely started can be prestored in the ROM 11b. In such an approach, when the engine is commanded to be started, the engine RPM display value change rate can be set less than the engine RPM measurement value change rate by referring to the second mapping table.

Alternatively, as shown in FIG. 9, the controller 11 can determine that the calculation timing arrives, when the engine RPM measurement value reaches a predetermined value NE2 after the stopped engine is commanded to be started (i.e., after the controller 11 receives the engine start command signal). In this case, the engine RPM measurement value change ratio can be calculated by dividing the predetermined value NE2 by a time period from when the engine is commanded to be started to when the engine RPM measurement value reaches the predetermined value NE2. Thus, the engine RPM display value change rate can be set less than the calculated engine RPM measurement value change rate.

In the above examples shown in FIGS. 4-9, the engine RPM display value changes at a constant rate. Alternatively, as shown in FIG. 10, the engine RPM display value can change at a non-constant rate. FIG. 10 illustrates a relationship between the engine RPM measurement value and the engine RPM display value from when the running engine is stopped to when the stopped engine is started. In this case, for example, the engine RPM display value change rate can be calculated by subtracting a predetermined value from the engine RPM measurement value change rate or by multiplying the engine RPM measurement value change rate by a predetermined coefficient less than one. In such an approach, the engine RPM display value can change at a non-constant rate by following the change in the engine RPM measurement value. The subtracted value and the multiplied coefficient can vary depending on the engine RPM display value.

When the calculation process shown in FIG. 3 is performed so that the engine RPM display value change rate can be different from the engine RPM measurement value change rate, a design of a meter display displayed on the display 20 can be different than usual. For example, as shown in FIG. 11, the brightness of the needle 203 of the mechanical meter 201 can change between when the calculation process is performed and when the calculation process is not performed. In an example shown in FIG. 11, when the calculation process is performed, the brightness of the light source 203c is set to a first value L0, and when the calculation process is not performed, the brightness of the light source 203c is set to a second value L1 greater than the first value L0. Thus, when the calculation process is performed, the needle 203 is illuminated more darkly than usual. Thus, a user can recognize that the calculation process is performed. Alternatively, when the calculation process is performed, the needle 203 can be illuminated more brightly than usual. Alternatively, the color of the needle 203 can change between when the calculation process is performed and when the calculation process is not performed.

Likewise, at least one of the brightness and color of the display area 22 can be changed between when the calculation process is performed and when the calculation process is not performed.

Likewise, when the display 20 is configured as a graphic meter, at least one of the brightness, color, and contrast can be changed between when the calculation process is performed and when the calculation process is not performed.

(Modifications)

The embodiment described above can be modified in various ways. For example, in the case of FIG. 11, when the brightness changes from a normal value or returns to the normal value, the brightness can change at a predetermined rate.

Such changes and modifications are to be understood as being within the scope of the present invention as defined by the appended claims.

What is claimed is:

1. An engine revolution meter for displaying a display value, the engine revolution meter comprising:
an obtaining device configured to obtain a measurement value corresponding to a measured revolution number of an engine of a vehicle;
a calculating device configured to calculate the display value based on the measurement value; and
a determining device configured to determine whether the measurement value is greater or less than a reference value, wherein
when the determining device determines that the measurement value is less than the reference value, the calculating device calculates the display value in such a manner that the display value changes at a first rate different from a second rate at which the measurement value changes.

2. The engine revolution meter according to claim 1, wherein
the first rate is less than the second rate.

3. The engine revolution meter according to claim 1, wherein
the first rate is a predetermined constant value.

4. The engine revolution meter according to claim 1, wherein
the first rate changes between at least two different values.

5. The engine revolution meter according to claim 1, further comprising:
an engine stop sensor configured to detect an engine stop command for causing the engine to be stopped, wherein
the measurement value decreases from a first value to a second value until the engine is stopped after the engine stop command is detected, and
the calculating device calculates the display value based on the measurement value decreasing from the first value to the second value.

6. The engine revolution meter according to claim 5, wherein
when a calculation timing arrives after the engine stop command is detected, the calculating device starts to calculate the display value based on the measurement value decreasing from the first value to the second value.

7. The engine revolution meter according to claim 6, wherein
when the measurement value becomes the second value after the engine stop command is detected, the calculation timing arrives.

8. The engine revolution meter according to claim 1, further comprising:
an engine start sensor configured to detect an engine start command for causing the engine to be started, wherein
when the engine is stopped, the measurement value has a third value, and
when the engine start command is detected, the calculating device calculates the display value based on the measurement value increasing from the third value to the reference value.

9. The engine revolution meter according to claim 8, wherein
when a calculation timing arrives after the engine start command is detected, the calculating device starts to calculate the display value based on the measurement value increasing from the third value to the reference value.

10. The engine revolution meter according to claim 9, wherein
when the measurement value exceeds a threshold value after the engine start command is detected, the calculation timing arrives.

11. The engine revolution meter according to claim 1, further comprising:
a display portion configured to display the display value in a predetermined design; and
a controller configured to change the design between when the display value changes at the first rate and when the display value does not change at the first rate.

12. The engine revolution meter according to claim 1, wherein
when the determining device determines that the measurement value is equal to or greater than the reference value, the calculating device calculates the display value in such a manner that the display value changes at the same rate as the measurement value.
